(19) United States
(12) Patent Application Publication
(10) Pub. No.: US 2010/0138852 A1
(43) Pub. Date: Jun. 3, 2010

(54) SYSTEM AND METHOD FOR THE PRESENTATION OF INTERACTIVE ADVERTISING QUIZZES

(76) Inventors: Alan Hirsch, Los Angeles, CA (US); Jack R. Cate, III, Los Angeles, CA (US)

Correspondence Address: PERKINS COIE LLP;PATENT-SEA, P.O. BOX 1247, SEATTLE, WA, 98111-1247, US

(21) Appl. No.: 12/629,025

(22) Filed: Dec. 1, 2009

Related U.S. Application Data
(63) Continuation-in-part of application No. 11/749,920, filed on May 17, 2007.
(60) Provisional application No. 61/119,007, filed on Dec. 1, 2008.
(60) Provisional application No. 61/139,502, filed on Dec. 19, 2008.

(51) Int. Cl. H04H 60/33; G06Q 30/00

(52) U.S. Cl. 725/13; 705/14.69; 705/14.55; 705/14.14; 725/23; 725/32

(57) ABSTRACT

A system and method for generating and presenting an interactive advertising quiz in conjunction with video media. The system generates an interactive advertising quiz having video content with one or more redacted elements. A redacted element may be, for example, a brand, logo, product, actor, or other identifier that is normally present in the video content. The system presents the interactive advertising quiz to a user and quizzes the user as to the identity of the missing element in the video content. The system receives the user's guess regarding the redacted element in the video content, and determines if the user's guess was correct. Correct guesses may result in incentives being awarded to the user. The interactive advertising content is shown in a post-roll position following online video content that has been shown to the user. The user may also challenge other users to play the interactive advertising quiz.

### CROSS-REFERENCE TO RELATED APPLICATIONS

This application is a continuation-in-part of U.S. Non-Provisional patent application Ser. No. 11/749,920, filed May 17, 2007, which is hereby incorporated herein in its entirety. This application claims the benefit of U.S. Provisional Application Ser. No. 61/119,007, filed Dec. 1, 2008, and U.S. Provisional Application Ser. No. 61/139,502, filed Dec. 19, 2008, each of which is hereby incorporated herein in its entirety.

### BACKGROUND

Innumerable World Wide Web media sites (“media sites”) serve online media content to users over the Internet. Most media sites generate revenue through advertisements that are displayed in conjunction with the online media content. Traditionally, such advertisements have been text advertisements or banner advertisements that are positioned in and around the media that is displayed to a user. Although text and banner advertisements have been the predominant form of advertising to users, such advertisements have historically suffered from low click-through rates. Low click-through rates suggest the limited success of text and banner advertisements in converting users to potential customers.

As media sites have expanded in sophistication, they have increased the use of video content to enhance the experience of a user. The video content used by media sites may include professional reporting, user-contributed clips, movies, television programs, movie trailers and music videos, or the like. While consumers have benefited from the addition of video content, media sites have struggled with integrating advertising with the displayed video content. Some media sites have attempted to integrate a still advertising image prior to the display of video content. Other sites have integrated pre-roll advertisements prior to the display of video content. A pre-roll Dec. 1, 2009 advertisement is a video or multimedia commercial that must be displayed in its entirety before a user may access requested video content. One drawback of each of these advertising methods is that they do not pique or hold a user's interest effectively. Most users are more interested in the requested video content, so will ignore pre-roll content as they wait for requested content. Moreover, some users may view a pre-roll advertisement but may not retain any substantial memory of the advertised product, service or brand, since the viewing of a pre-roll advertisement is a passive activity. Finally, while online advertising networks have been able to provide data on the numbers of viewers, click-though rates and time spent viewing pages, there has been a lack of metrics with advertising that comprehensively provide advertisers with actual user exposure and engagement in the advertising content. Accordingly, the need exists for improved methods for advertisers to reach viewers of video content in a manner that is non-intrusive, interesting, and effective.

### BRIEF DESCRIPTION OF THE DRAWINGS

FIG. 1A illustrates a first exemplary environment in which a system for the presentation of interactive advertising quizzes operates.

FIG. 1B illustrates a second exemplary environment in which a system for the presentation of interactive advertising quizzes operates.

FIGS. 2A-2E depict an exemplary timeline demonstrating the integration of an interactive advertising quiz with media.

FIG. 2F depicts an exemplary screenshot of an interactive advertising quiz that may be integrated with media.

FIG. 3 is a block diagram of system components for the presentation of an interactive advertising quiz.

FIG. 4 is a flowchart of a process for processing video content for use in an interactive advertising quiz.

FIG. 5 is a flowchart of a process for presenting an interactive advertising quiz with media.

FIG. 6 is a flowchart of a process for selecting redacted video content for an interactive advertising quiz.

### DETAILED DESCRIPTION

A system and method for generating and presenting an interactive advertising quiz (or “quiz”) in conjunction with media such as online video media is disclosed. The system generates an interactive advertising quiz having video content with one or more redacted elements. A redacted element may be, for example, a brand, logo, product, actor, or other identifier that is normally present in the video content. The system presents the interactive advertising quiz to a user and quizzes the user as to the identity of the missing element in the video content. The system receives the user's guess regarding the redacted element or elements in the video content, and determines if the user's guess was correct. Correct guesses may result in incentives being awarded to the user. By inviting the user to guess the missing element(s) in the video content, the disclosed system and method results in greater engagement by a user and better overall brand recognition and recall by the user than traditional static advertisements.

In some embodiments, the interactive advertising quiz is presented after other requested media has been viewed by the user. Such a presentation is referred to herein as a “post-roll” presentation. The interactive advertising quiz may be presented by itself in the post-roll position, or may be integrated with other typical content that appears at the end of requested media. For example, the interactive advertising quiz may be presented in parallel with the media credits of the requested media.

In some embodiments, the system targets the interactive advertising quiz to a user based on the requested media. For example, the system may select particular quiz content based on the requested media that was recently viewed by the user or based on the referring media site. The system may also target the interactive advertising quiz based on information about the user. For example, the system may select particular quiz content based on the user's past quiz history and the user's personal information. The use of tailored, interactive advertising quizzes improves a user's recollection of the advertised product or service by engaging the user more than a static or non-interactive commercial.

In some embodiments, the system permits a user to challenge one or more other users to compete in an interactive advertising quiz. The user is allowed to play the interactive advertising quiz in a live challenge mode wherein the user's answers are compared against the challenged other users. Quiz challenges by the user may occur in a social networking site or across social networking sites.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

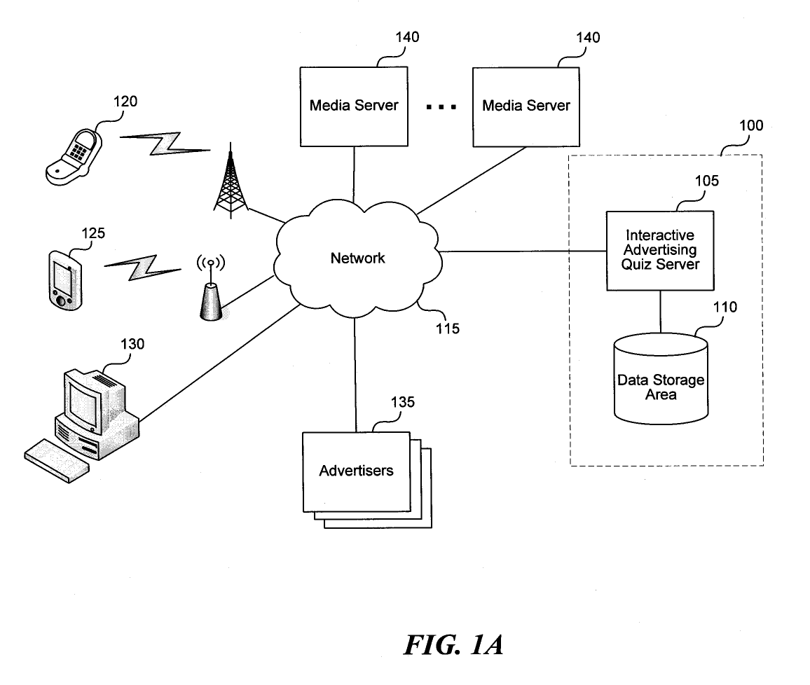

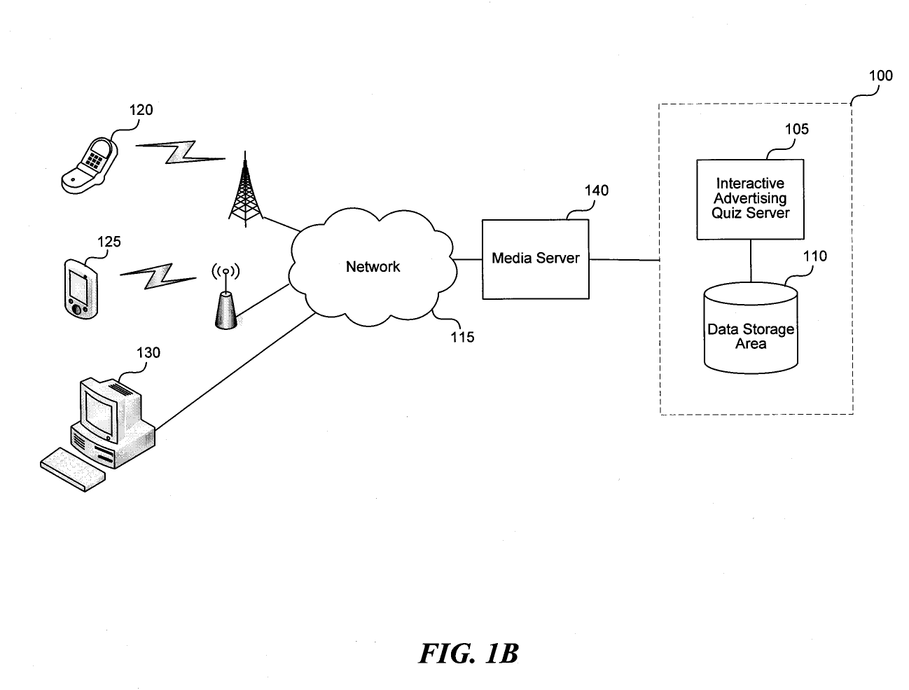

FIG. 1A illustrates an exemplary environment in which a system 100 for the presentation of interactive advertising quizzes operates. Users of mobile phones 120, personal digital assistants 125, laptop or desktop personal computers 130 or any other suitable networked client devices may connect over a network 115 to a media site hosted by a media server 140. The network 115 may be the Internet or any other public, private, wired or wireless, local area or wide area network. The user requests from the media site the display of video media such as movies, television programs, movie trailers, webisodes, personal videos, news videos, music videos, or the like. The media server 140 serves the requested media to the user.

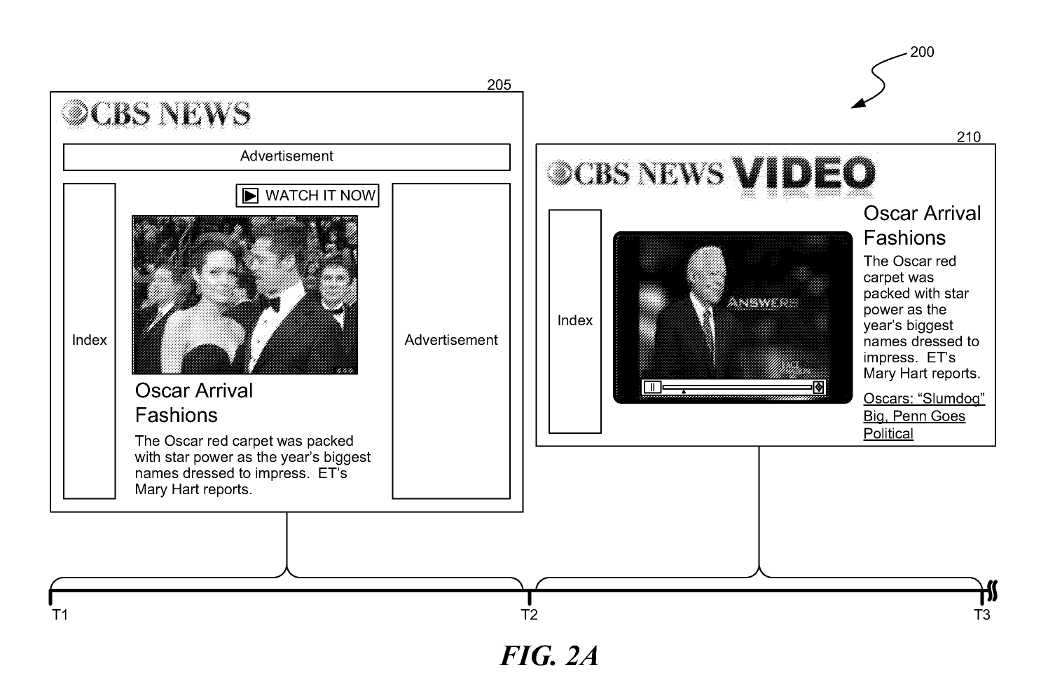

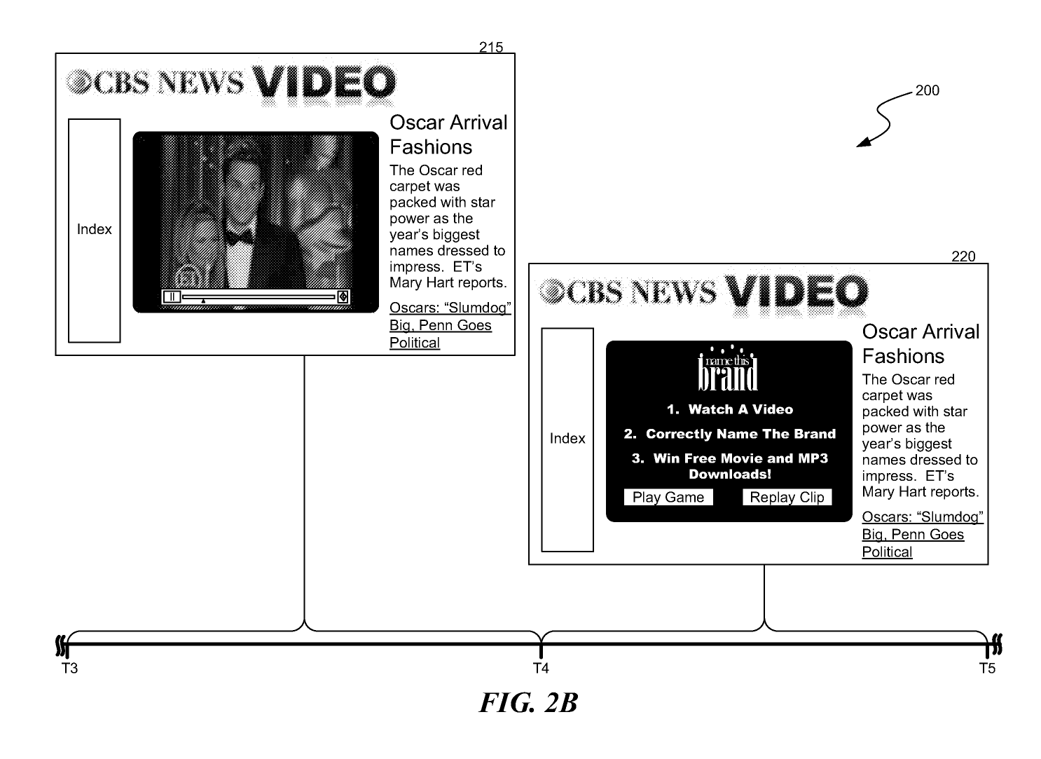

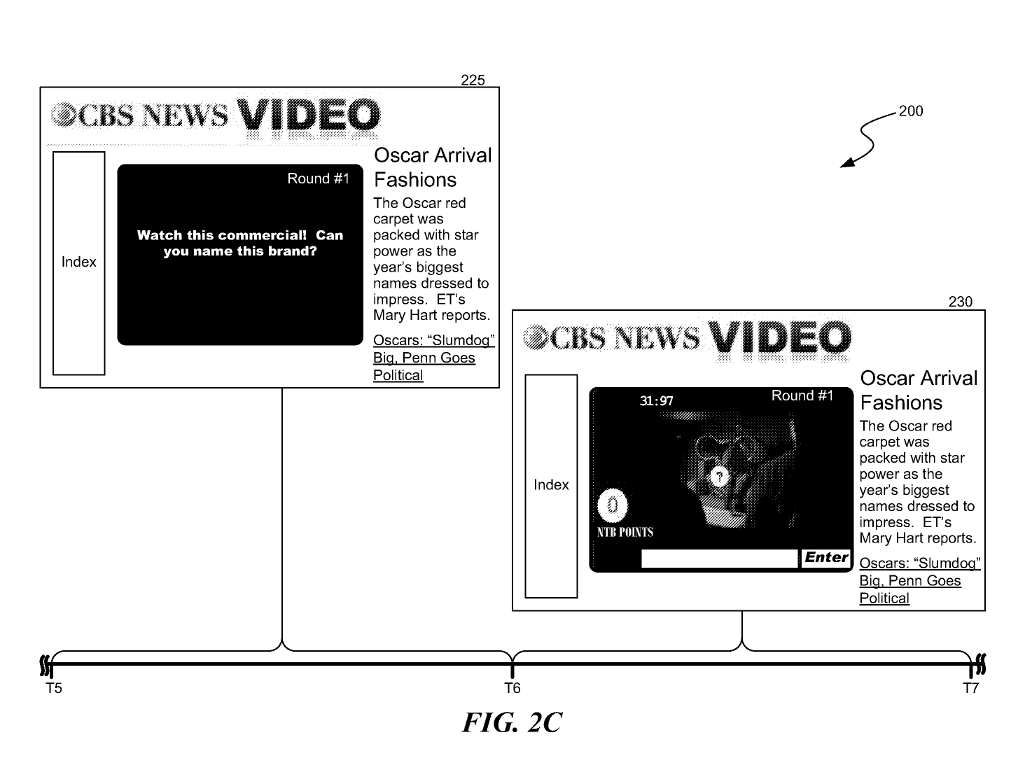

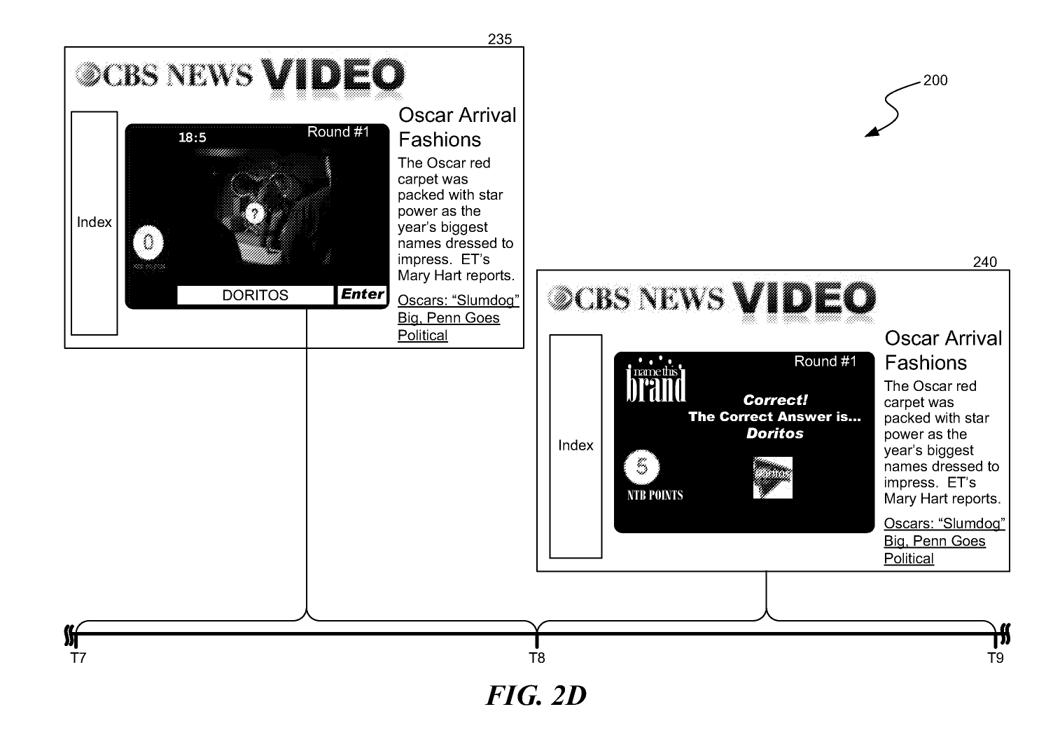

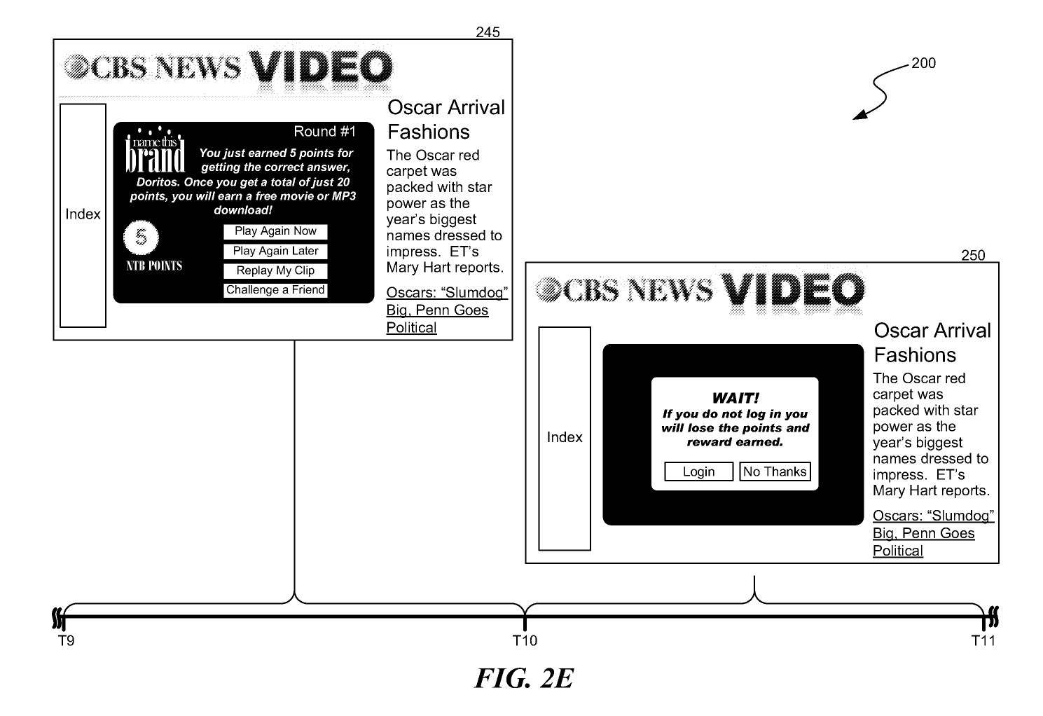

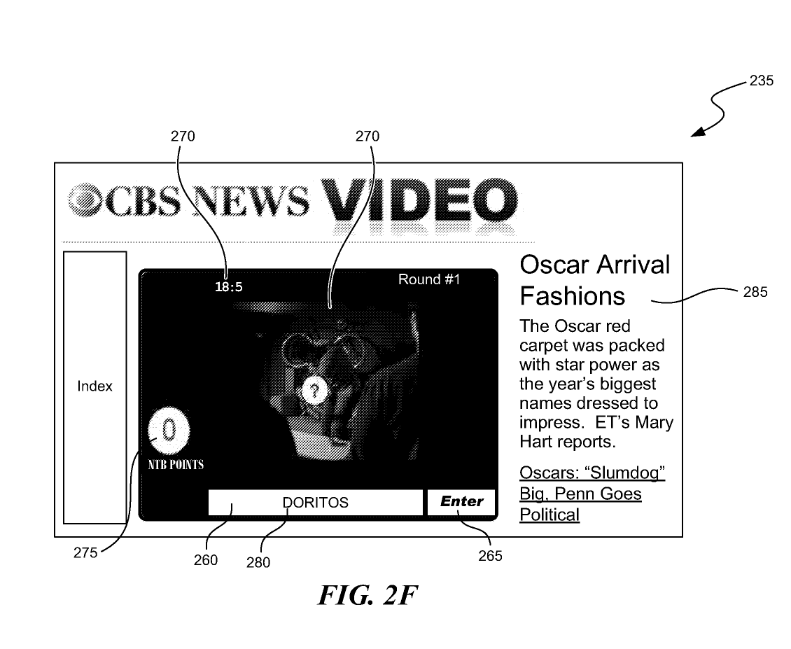

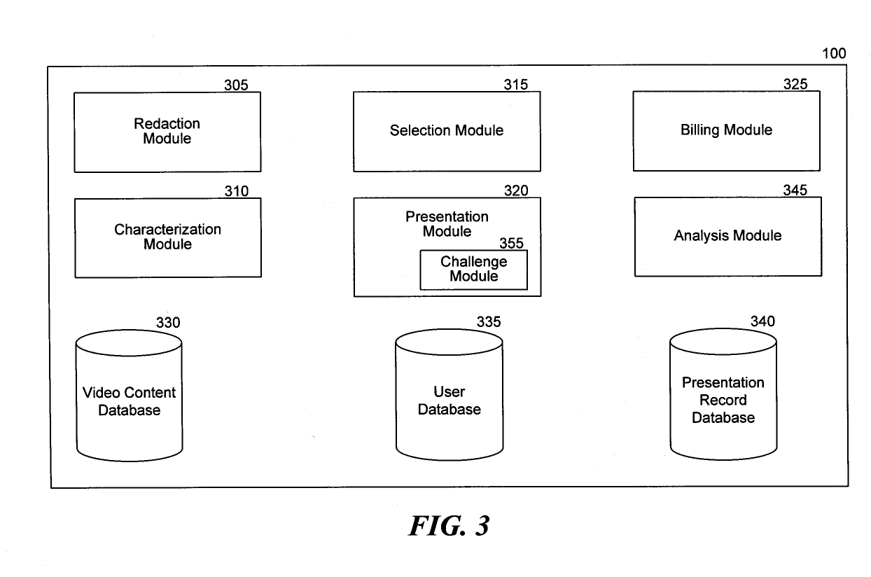

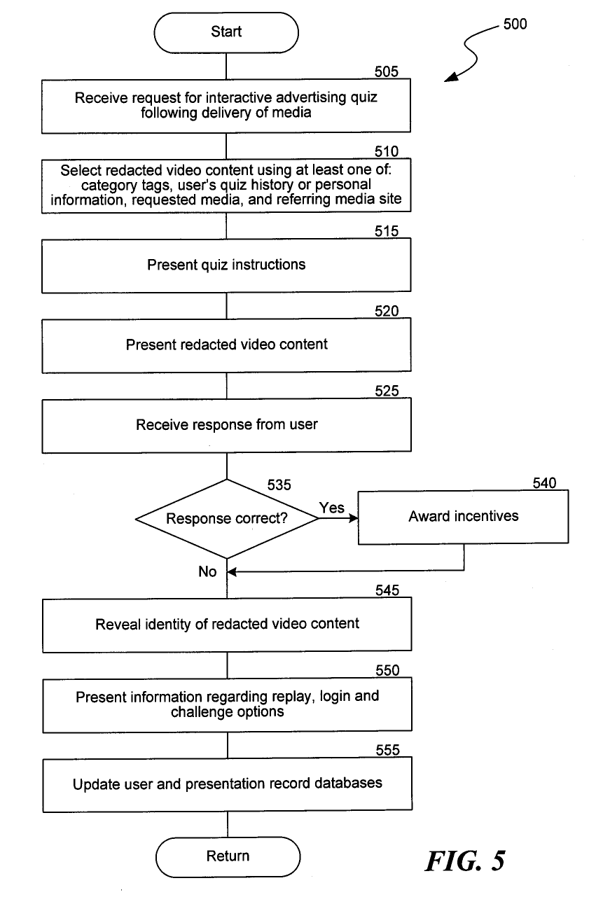

An interactive advertising quiz server 105 serves an interactive advertising quiz to the user, typically after the media server 140 serves the requested media to the user. Interactive advertising quiz server 105 accesses user data, video content data, billing data, historical presentation data, and/or other data in a data storage area 110 to permit the server 105 to serve interactive advertising quizzes to users, to award incentives to users, and to facilitate the collection of advertising revenue. The format and content of a typical interactive advertising quiz is discussed in greater detail with respect to FIGS. 2A-2F and 5. The operation of the interactive advertising quiz server 105 and associated methods are discussed in greater detail with respect to FIGS. 3-6.

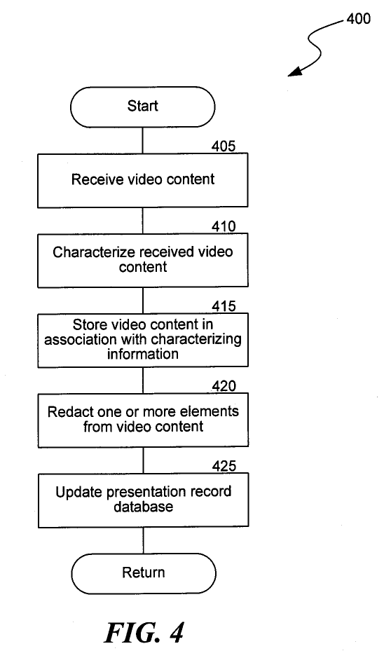

Advertisers 135 send video content to the interactive advertising quiz server 105 over the network 115 for subsequent inclusion in interactive advertising quizzes. Alternatively, advertisers 135 may send video content to the interactive advertising quiz server 105 through other manual means not involving the network 115, such as by optical discs, flash drives, or other storage means. As discussed in greater detail with respect to FIGS. 3 and 4, the interactive advertising quiz server 105 may prepare or modify the video content received from the advertiser 135 for subsequent inclusion in interactive advertising quizzes.

Typically, an advertiser 135 is a traditional advertiser such as a for-profit company having a commercial product or service, an advertising firm, or an advertising broker. However, one skilled in the art will appreciate that the term “advertiser” may also encompass others who have a commercial or non-commercial interest in promoting consumer recognition or awareness of an entire class of products or services, a political or social issue, an entity or organization, a celebrity or other person, or similar.

Typically, as shown in FIG. 1A, two different business entities will operate the media server 140 and the interactive advertising quiz server 105 on physically separate machines. However, as shown in FIG. 1B, a single business entity may operate both the media server 140 and the interactive advertising quiz server 105. In such environments, the two servers may be integrated into a common content-delivery platform that resides on one or more physical machines. In the configuration depicted in FIG. 1B, the operator of the media server 140 utilizes the advertising quiz server to create and present its own interactive advertising quizzes on its media site. The advertising quizzes that are created may be based on internally-generated video content, or may be based on video content received from external sources.

FIGS. 2A-2E depict an exemplary timeline 200 demonstrating the presentation and integration of an interactive advertising quiz with media. Each numbered frame in the timeline 200 depicts a screen shot illustrating the content that may be presented to a user at a particular time by a media server 140 and/or the interactive advertising quiz server 105.

As shown in frame 205, at time T1 a user accesses a media site. Typically the user accesses or navigates to the media site using a general purpose web browser or similar software on the user's client device. The web browser or software on the client's device is capable of running a client-side application such as an applet, JavaScript, Flash player, or similar. Non-exclusive examples of media sites include World Wide Web (WWW) sites related to newspapers, broadcast or cable television programming, media portals (e.g., Yahoo!, Hulu.com, YouTube.com, and Nabbr.com), movies (e.g., IMDB.com, Netflix), music recordings, music videos, and the like. In the exemplary timeline 200, at frame 205 the user accesses a media site related to the CBS television network.

After accessing the media site, the user may request media from the media site. In exemplary frame 205, the user clicks on a linked text or image to request the display of an Entertainment Tonight® video segment pertaining to “Oscar Arrival Fashions.”

As shown at frame 210, at time T2, the media server 140 may present a pre-roll advertisement to the user in an embedded or external media player prior to presenting the requested media. In the exemplary frame 210, the media server 140 presents a multimedia commercial pertaining to another television program broadcast by the CBS network. Often the user will be unable to skip over or through a pre-roll advertisement using video controls such as fast-forwarding. Alternatively, the user may have an option to skip the pre-roll advertisement altogether or to fast-forward through it.

As shown at frame 215, at time T3, the media server 140 presents the requested media to the user in an embedded or external media player that may be implemented in whole or in part by a client-side application such as an applet, JavaScript, flash player, or similar. Generally, during the presentation of the requested media, the media player will permit the user to fast-forward, rewind, pause or otherwise perform similar functions via video controls.

Exemplary frames 220-245 illustrate the phases of an interactive advertising quiz that is designed to advertise a product, service, brand, organization, or other event in a manner that is engaging to a user and which reinforces the underlying goal of the advertiser. Typically, an interactive advertising quiz appears seamlessly integrated into a media site via framing, embedded linking or coding, or similar techniques such that the user remains unaware of any business or physical separation that may exist between the presenting media site and the operator of the interactive advertising quiz system 100. Alternatively, after presenting the requested media, the media site may automatically redirect the user to another website which presents the interactive advertising quiz, or the user may navigate to such a website via a link or similar. To facilitate presentation of the interactive advertising quiz and receive user responses from the quiz, the user's networked client device (e.g., mobile phones 120, personal digital assistants 125, laptop or desktop personal computers 130) will typically download and execute (generally via a general purpose web browser) a client-side application such as an applet, JavaScript, flash player, or similar. The client-side application enables two-way interaction between the system 100 and the user, including the presentation of video content to the user and the receipt of user responses. While frames 220-245 depict the quiz as embedded within a media site, one skilled in the art will appreciate that some or all portions of the interactive advertising quiz may be embedded in another website or other framing content.

As shown at frame 220, the interactive advertising quiz begins at time T4 with the presentation of one or more introductory pages by the system 100 that provide the user with an overview of the interactive advertising quiz. In addition to, or in lieu of a textual overview, the introductory page may utilize multimedia effects such as still images, sound effects, music, voiceovers, animation or video to explain the interactive advertising quiz. As shown at frame 220, an introductory page may provide the user with various options, including playing the interactive advertising quiz and replaying the requested media. One skilled in the art will appreciate that the quiz may omit the introductory page and/or some of the illustrated options or information, particularly if the system 100 determines that the requesting user has previously played an interactive advertising quiz.

As shown at frame 225, at time T5, if the user agrees to play the interactive advertising quiz, the system 100 presents quiz instructions. Instructions typically pose a question to the user about the upcoming video content. The system may tailor the instructions to the particular upcoming video content (e.g., “Watch this mouth-watering commercial! Can you name this snack brand?”), or provide more generic quiz instructions (e.g., “Watch this commercial! Can you name this brand?”). In addition to, or in lieu of textual instructions, the instruction page may include multimedia effects such as still images, sound effects, music, voice-overs, animation or video. Depending on the complexity of the quiz or the previous experience of the requesting user, the system may omit quiz instructions altogether or integrate instructions with the content of another frame in timeline 200.

As shown in frame 230, at time T6, the system 100 presents redacted video content to the user. In the depicted example, the system presents a video commercial for a product with the advertised product (Doritos® brand chips) redacted by an overlaid question mark. The overlaid question mark obscures the product to prevent ready consumer recognition of the brand.

To attract the user's attention and to present a more seamless experience with the requested media that the user previously viewed, the system 100 uses video content in the interactive advertising quiz. Preferably, video content used in an interactive advertising quiz has a duration of about twenty seconds to about one minute. Such a range is sufficient to provide context to a user and capture the user's attention, but is not so long as to preclude the presentation of multiple interactive advertising quizzes to the user within a short period of time. Those skilled in the art will appreciate, however, that video content having a duration shorter than about ten seconds and longer than about one minute fall within the scope of the present invention. Video content may be stored in any suitable format, including, but not limited to .mpeg, .wmv, .swf, .mov and any combination thereof. Although redacted video content is primarily described herein, one skilled in the art will understand that interactive advertising quizzes may incorporate media forms other than video content, including still images or pictures, text, and audio clips.

Redacted content is content in which an element has been omitted or not included, or content in which an element has been blurred, scrambled, obscured, anagrammed, or otherwise altered or edited such that the element is unrecognizable or significantly less perceivable by a viewer than it was in unredacted or unedited content. Redaction may be visual (i.e., a visual element is removed from the video content), auditory (i.e., an audible element is removed from the video content) or both.

Redacted elements may include a brand; a logo; product packaging; identity or name of a product, service, person, fictional character, entity, group or organization; a musical lyric or passage; a sound such as a lyric, punchline, or distinctive phrase; a word, phrase or slogan; or any other identifying indicia that would assist the user in answering the question(s) posed to them by the interactive advertising quiz. Typically, a redacted element is a piece of information that the advertiser 135 would like the user to recollect after participating in the interactive advertising quiz. Since an advertiser may determine what element to redact from the video content, the advertiser is able to create quizzes that reinforce the messaging or communication strategy of the brand. While the depicted example focuses on video content from which a brand, logo, slogan, product package, product, or a product or service name has been redacted, one skilled in the art will appreciate that the system and method described herein may redact other kinds of elements as well.

In some embodiments, the system 100 may redact more than one element from a single piece of video content (e.g., both a logo and a product may be obscured in a video commercial) and/or use more than one method of redaction in a single piece of video content (e.g., both auditory and visual redaction). In some embodiments, more than one brand may be redacted from video content. A further discussion of the method of redacting elements from video content is provided with respect to FIGS. 3 and 4.

As shown in frame 235, at time T7, the system 100 presents an answer field in which a user may enter their response regarding the question posed to them while watching the redacted video content. In the depicted example, the user enters a guess of the advertised brand (“Doritos”) while the redacted video commercial plays. The entry of a response may immediately end the presentation of the redacted video content. Alternatively, the quiz may continue to present the redacted video content after the response until the end of the redacted video content is reached.

As shown at frame 240, at time T8, the system 100 indicates to the user whether the received response is correct or incorrect. In the depicted example, the system congratulates the user for correctly answering the question posed in the interactive advertising quiz.

Additionally, as shown at frame 240, the system 100 may reveal the identity of the redacted video content. The system may reveal the identity of the redacted content by showing a correct answer to the question posed, or by presenting other information that the advertiser wishes the user to retain or recollect after the conclusion of the quiz. The system may also reveal the identity of the redacted element by presenting an unredacted form of the video content to the user. In the depicted example, the advertised product (a bag of Doritos® brand chips) was the redacted element. However, in frame 240, the system reveals the identity of the redacted element not by displaying the redacted element itself (i.e., the bag of chips), but instead by presenting the brand name and logo (i.e., Doritos®).

As shown at frame 245, at time T9, the system 100 may present various options to the user after they have completed one round of the interactive advertising quiz. These options may include playing another round of the interactive advertising quiz immediately or later; challenging another user to participate in an interactive advertising quiz; or replaying the requested media.

As shown in frames 240-250, the system 100 may award incentives to the user as the result of a correct response. Incentives awarded to the user may include cash, products (including e-book, music or video downloads), coupons, gift certificates, or services (collectively “prizes”). In some embodiments, the incentive may be “incentive points” that the user may accrue or redeem for prizes. In still other embodiments, the user may receive a sweepstakes entry that qualifies the user for a chance to win prizes. As shown in the exemplary frames 240-250, the depicted quiz awarded the user five incentive points for correctly guessing the Doritos® brand. In some embodiments, the system may award incentives even for incorrect responses, albeit at a reduced value when compared with correct responses.

As shown at frame 250, at time T10, if the user attempts to quit the interactive advertising quiz without playing another round, the system may encourage the user to log in or otherwise provide identifying information. By logging in, the user ensures that the awarded incentives are credited to the user. Moreover, the user may also redeem or audit the amount of awarded incentives.

FIGS. 2A-E depict a “post-roll” format of an interactive advertising quiz, with the quiz appearing subsequent to the presentation of requested media. Typically an interactive advertising quiz is presented by the system after the requested media displays in its entirety, or after the user advances through its entirety using control functions. However, one skilled in the art will appreciate that the system may have another ordering or sequence or omit certain portions of the content shown in the exemplary frames 220-250 altogether. For example, the system may present the interactive advertising quiz in a pre-roll format with the quiz preceding the requested media; the system may present the quiz in parallel with video media credits squeezed into a side bar; or the system may sandwich the quiz between two media segments, e.g., as a mid-show commercial break.

FIG. 2F shows an exemplary screenshot of an interactive advertising quiz. It depicts frame 235 from FIG. 2D in greater detail to illustrate the graphical interface features of the interactive advertising quiz. The graphical interface is typically implemented as a webpage. As shown in FIG. 2F, the system generates a graphical interface having a media player region 255, a timer display 270, an incentives display 275, an entry field 260, and an “enter” button 265. In the depicted example, the interactive advertising quiz is surrounded by framing content 285 of the CBS News website.

The media player region 255 permits the embedded display of redacted video content, including redacted advertising commercials, during an interactive advertising quiz. The media player region 255 is typically implemented via a client-side application such as an applet, JavaScript, Flash Player, or similar, that enables two-way interaction between the system 100 and the user, including the presentation of video content to the user and monitoring of user responses. One skilled in the art will recognize that numerous media players, including Adobe® Flash Player or Microsoft® Media Player, permit the display of embedded video within a webpage.

The timer display 270 displays one or more of the following: (1) the time remaining in the redacted video content, (2) the time remaining for the user to answer the question posed, or (3) the time elapsed since the start of the redacted video content.

The incentives display 275 shows the user the quantity and/or type of incentives the user collects as a result of participating in the current interactive advertising quiz, and/or the amount of incentives that the user has accrued as a result of participating in past interactive advertising quizzes. The incentives display 275 may induce longer user participation since it encourages the user to earn incentives by continued play. The incentives display 275 may also cause higher rates of user logins since it reminds the user that they may forego earned incentives by playing anonymously.

The entry field 260 and “enter” button 265 provide the user with means to enter his guess or response 280 regarding the posed question. The user may enter the response 200 using common input devices on his client device, such as a keyboard, touch screen, mouse, voice recognition, etc. In some embodiments, a multiple-choice or dropdown menu may replace an entry field to allow a user to enter a desired response.

The optional framing content 285 may provide additional information or options to the user that relate to the interactive advertising quiz, the requested media, the referring media site, or other advertisements.

In some embodiments, the system 100 may generate additional controls suitable for providing additional information about, or control over, the interactive advertising quiz. For example, the system may generate drop-down menus or other controls (not shown) that provide means for a user to: review a “leaderboard” of user scores; send challenges to other users or persons; see what incentives are available, earned or redeemed; share the interactive advertising quiz with others by email, social networking site, blog, RSS feed or similar; provide log in information; embed an interactive advertising quiz in a website; provide feedback about a quiz; or receive help or instructions. The system may vary the user interface for the interactive advertising quiz as the user reaches different phases in the timeline 200.

FIG. 3 is a block diagram of the components of the system 100 for presenting an interactive advertising quiz. The system 100 has a redaction module 305 and a categorization module 310 to prepare video content for presentation in an interactive advertising quiz, a selection module 315 and a presentation module 320 (which may further comprise a challenge module 355) for presenting an interactive advertising quiz to one or more users, and a billing module 325 and an analysis module 345 for charging advertisers and mining the record of delivered interactive advertising quizzes for efficacy and proof of engagement. Each module will be described in turn herein. During operation, the system 100 may access various data stores, including a video content database 330, a user database 335, and a presentation record database 340. Those skilled in the art will appreciate that the actual implementation of the databases may take a variety of forms, and the phrase “database” is used herein in the generic sense to refer to any area that allows data to be stored in a structured and accessible fashion using such applications or constructs as databases, tables, linked lists, arrays, and so on.

The redaction module 305 is configured to receive video content such as advertising commercials and to redact elements from the video content. The functionality of redaction module 305 will be discussed in greater detail with respect to FIG. 4.

The characterization module 310 is configured to characterize received video content. The characterization information derived by this module may be later used by the selection module 315. The functionality of characterization module 310 will be discussed in greater detail with respect to FIG. 4.

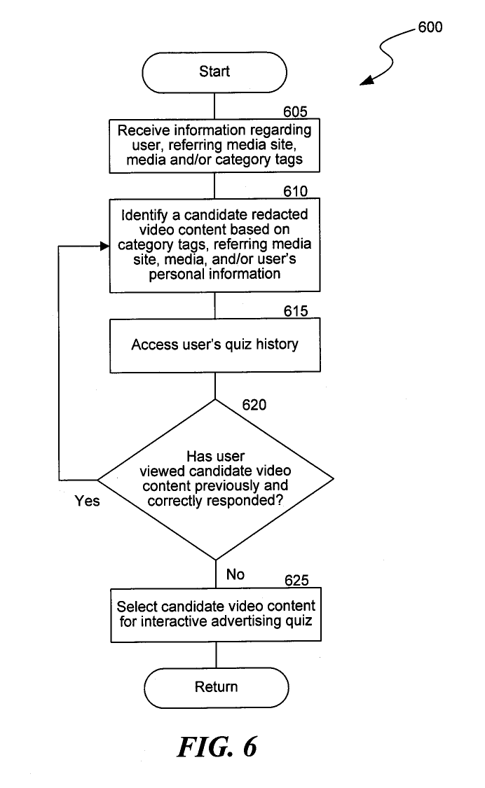

The selection module 315 is configured to select redacted video content for inclusion in an interactive advertising quiz. The functionality of selection module 315 will be discussed in greater detail with respect to FIG. 6.

The presentation module 320 is configured to receive requests for interactive advertising quizzes, deliver redacted video content, receive responses from the user, and analyze user responses. The presentation module 320 may include a challenge module 355 that permits the system 100 to offer an interactive advertising quiz in either challenge or live challenge modes, wherein two or more users compete against one another. The functionality of the presentation module 320, including the challenge module 355, will be discussed in greater detail with respect to FIG. 5.

The billing module 325 is configured to permit the system 100 to bill advertisers or others for services provided. The billing module 325 is configured to track system activity, billing and payments received.

The analysis module 345 is configured to permit the system 100 to analyze the past delivery of interactive advertising quizzes and assess the efficacy of the quizzes based on user responses. The analysis module 345 allows the system 100 to mine historical data in order to identify those quizzes that are more effective at engaging users and those quizzes that are less effective at engaging users. By mining the historical data, the system is able to generate more effective interactive advertising quizzes for presentation to users. Moreover, the system is able to provide information to advertisers about which user demographics are able to accurately identify the missing elements in the interactive advertising quizzes and which user demographics are unable to accurately identify the missing elements. That is, the system 100 may review past responses from users, identify clusters of users that answered the questions correctly and that share common characteristics, and provide a characterization of the clusters to the advertisers. Advertisers are able to use such clusters to understand the performance of the advertisements that they are running and design improved advertisements in the future. The system may also make available a record of the results of all interactive advertising quizzes that are presented to users so that the advertisers are able to judge the efficacy of the advertisements and the return on their advertising spend. For example, the system can provide the following data to advertisers: (i) an identification of groups of users, sortable by different demographic characteristics, that answered correctly or incorrectly; (ii) the time (e.g., shortest, average, longest) that it took for users to answer a question in an interactive advertising quiz; (iii) an identification of users by geographic region (e.g., city, state, country) where the users correctly or incorrectly responded to the interactive advertising quiz; and (iv) an identification of incorrect answers that were submitted by users and the frequency of each incorrect answer. All of this data is valuable to assist advertisers in better understanding the efficacy of their advertising.

The video content database 330 stores video content in original (i.e., unredacted) and/or in redacted form. The video content database 330 may store each piece of redacted video content in association with: the corresponding piece of unredacted video content; tailored quiz questions; a set of correct answers responsive to the questions; the run-time of the redacted video content; the time window during which the video content should be shown (e.g., an expiration date of the video content); identifying information to reveal during the quiz; incentives rules specifying the quantity and/or type of incentives available to viewers of the video content; and the advertiser that was the source of the video content. In some embodiments, the video content database 330 may associate more than one piece of redacted video content with a particular piece of unredacted video content.

The video content database 330 also stores data to aid in the selection of redacted video content for quizzes. In some embodiments, the video content database 330 may associate each redacted piece of video content with metadata characterizing the video content. The video content database 330 may also contain general selection rules that describe when certain video content should be selected, based on factors such as the personal information or quiz history of the user, the referring media site, or the requested media.

The user database 335 stores information relating to users of interactive advertising quizzes. Stored information may include: user name; password; quiz history, e.g., redacted video contents viewed, correct/incorrect responses to the quizzes, past referring sites or requested media; incentives awarded and/or redeemed; personal information, including name, phone, address, zip code, demographic information (e.g., sex, age, profession, income, education) and personal interests (e.g., favorite hobbies, sports, authors, books, movies, activities, etc.); email address; password hints; or similar. In some embodiments, some or all of the user database 335 may be maintained separately from the rest of the system 100 and/or may be managed by a third-party entity. For example, some embodiments may utilize Facebook, MySpace or other social networking services or sites to manage some portion of the user database 335.

The presentation record database 340 stores historical information pertaining to the presentation of interactive advertising quizzes, the responses to the quizzes (both correct and incorrect), and the actions that a user takes after participating in or being exposed to a quiz. The presentation record database 340 permits the system 100 to bill advertisers or others for interactive advertising quizzes presented on behalf of an advertiser. The presentation record database 340 also allows the system to analyze the performance of past interactive advertising quizzes in order to improve the performance of future quizzes. The presentation record database 340 may associate each advertiser who uses the system 100 with relevant information such as: contact name, company name, email address, address, phone, username/password, billing method, and credit card or account information. Furthermore, the presentation record database 340 associates each advertiser with redacted or unredacted video content in the video content database 330, as well as various billing metrics for each associated interactive advertising quiz. Billing metrics might include set-up and redaction fees, number of page views of an interactive advertising quiz, number of user responses, number of correct or incorrect user responses, or quantity or type of incentives awarded to viewers of an interactive advertising quiz. The presentation record database 340 may also associate each advertiser with information relating to past payment history.

Those skilled in the art will appreciate that the system 100 may be implemented on any computing system or device. Suitable computing systems or devices include server computers, multiprocessor systems, microprocessor-based systems, minicomputers, mainframe computers, distributed computing environments that include any of the foregoing, and the like. Such computing systems or devices may include one or more processors that execute software to perform the functions and modules described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed across multiple computing systems or devices as desired in various embodiments.

FIG. 4 is a flowchart of a process 400 that is implemented by the redaction module 305 and the characterization module 310 for processing video content for inclusion in an interactive advertising quiz. The process 400 begins at block 405 when the system 100 receives unredacted video content from an advertiser. The system may receive the video content in conjunction with characterizing information such as: identifying information regarding the advertiser; selection rules of when the video content should be used; information categorizing the video content; redaction information (e.g., the elements to redact, a desired method of redaction); incentives rules; and identifying information (i.e., the information to display to the user after a response is received). The system may receive the video content by email message, response from a web form, file transfer protocol, or any other suitable means.

At block 410, the system 100 characterizes the received video content for later retrieval. The video content is indexed for later retrieval by the assignment of one or more pieces of metadata that characterizes the video content. Metadata characterizing the video content may include, for example, the type of product/service that is being advertised, the format of the video content (e.g., black and white, color, high definition, compressed), the target demographic groups of the video content (e.g., age, gender, profession of target users), a list of target media or media sites that the video content may be beneficially associated with, and/or any keywords associated with the text, image, and/or sound content of the video content. Characterization of the video content may occur manually; for example, an administrator of the system 100 may review the video content and select appropriate characterizing metadata. Alternatively additionally, content-based characterization may be partially or fully automated by the system based on sound-, image- and/or video-processing techniques such as: (1) acoustic fingerprinting, to permit characterization of video content on the basis of sound; (2) speech recognition, to permit characterization of video content on the basis of spoken language in the video content; (3) optical or digital character recognition, to permit characterization on the basis of text content that is contained in or associated with the video content; (4) color histogram, color moment, shape, texture, or feature extraction to permit content-based image characterization, including either query by example or semantic retrieval; (5) statistical video motion techniques to permit characterization of video content on the basis of video features or fingerprints.

Alternatively, rather than characterizing the received video content itself, the system 100 may utilize only the characterizations received from the advertiser.

At block 415, the system 100 stores and associates the received video content with derived and/or received metadata, selection rules, or other characterizing information in the video content database 330. The system 100 may also store any other information received at block 405 in association with the received video content.

At block 420, the system 100 redacts one or more elements from the video content to create redacted video content. The system 100 stores the redacted video content in the video content database 330 in association with the unredacted video content and its categorization information. As described previously, redaction may be visual, auditory or both. Examples of visual redaction include blurring, scrambling, obscuring, or anagramming an element, and eliminating entire video frames containing an element. Examples of auditory redaction include dropping the volume of an audio track; skipping a portion of an audio track; garbling, filtering or scrambling a sound; or replacing or overlaying a portion of an audio track with a sound or music.

The redaction at block 420 may occur in a partially manual or automated fashion. An administrator may use video, image or sound editing software to implement the redaction of video content elements manually. Additionally or alternatively, the redaction may be fully or partially automated. The system 100 may first use automated identification techniques to detect which portions of the video content comprise the element that is to be redacted. Once the identification determination is complete, an administrator may redact the video content by manually redacting only the detected portions. Alternatively, the system 100 may automatically redact the desired elements from the detected portions. To effectuate semi- or fully-automated redaction, the system 100 may utilize those sound-, image- and video-processing techniques described previously at block 410 for both the identification and redaction sub-blocks.

In some embodiments, to automate redaction of video content, the system 100 may segment the video content into sequential video segments and use scene detection software to detect which scenes comprise the elements to be redacted.

In some embodiments, the process 400 may repeat the redaction block 420 to create multiple different redacted versions of a piece of unredacted video content. For example, the system 100 may create a first version of a certain piece of video content by redacting a slogan using auditory redaction methods and create a second version of the same piece of video content by visually obscuring a product. As another example, the system 100 may create a single redacted piece of video content with two elements redacted.

In some embodiments, the system 100 may receive from the advertiser both a redacted and unredacted version of video content. If redacted versions of video content are received directly from an advertiser, the system may use the received version rather than create its own redacted versions.

At block 425, the system 100 may update the presentation record database 340 by associating the received identifying information about the advertiser with the redacted video content. The system 100 may also charge the advertiser for any set-up or redaction fees that it typically charges to create redacted video content.

In some embodiments, more than one brand may be redacted from a piece of video content. One skilled in the art will appreciate that in such embodiments, the video content database 330 may associate a redacted piece of video content with more than one advertiser.

FIG. 5 is a flowchart of a process 500 implemented by the presentation module 320 for presenting an interactive advertising quiz. The process 500 starts at block 505, when the system 100 receives a request for an interactive advertising quiz, typically following the delivery of requested media to a user. As described previously, this request may result from an embedded link or code within a media site. The received request may include information regarding: the referring media site in which the interactive advertising quiz is to be embedded, the media requested by the user, metadata characterizing the desired content of the interactive advertising quiz, and/or any known personal information about the user.

At block 510, the system 100 selects a redacted piece of video content from the video content database 330 using at least one of: the metadata characterizing the video content, the user's quiz history or personal information, characteristics of the requested media that would precede the interactive advertising quiz (e.g., the genre or subject matter of the requested media), or the identity of the referring media site. The selection process for block 510 is described in greater detail with respect to FIG. 6.

At block 515, the system 100 presents the quiz instructions to the user. Typically, the system 100 accesses instructions stored in association with the selected redacted video content in the video content database 330. As discussed previously with respect to FIG. 2A-2E, the system 100 may present quiz-level and/or video content-specific instructions. Typically the instructions will pose a question to the user as described previously.

At block 520, the system 100 presents the selected redacted video content to the user. Because of the high efficacy rate, the system 100 typically presents the redacted video content following the delivery of requested media to the user (i.e., in a post-roll format). However, the system 100 may present the redacted video content at another time. For example, the system may present the redacted video content as pre-roll content, as a mid-show commercial break, or during the display of squeezed media credits. Typically the user will view the redacted video content in a graphical interface similar to that shown in FIG. 2F, which has a field for the user to enter responses via input devices.

In a preferred embodiment, the system 100 presents the video content from which one or more elements has been redacted. However, other types of content may be served (e.g., still images with an element that is redacted, music with redacted lyrics, etc.).

At block 525, the system 100 receives a response from the user regarding the question posed by the interactive advertising quiz. Typically the system 100 receives the response via user input into an entry field 260 such as the one shown in FIG. 2F. The system may record an elapsed time when the response is received from the user. Recording the elapsed time of each response allows the system to identify how quickly users are responding to an interactive advertising quiz, and report such information to advertisers.

At decision block 535, the system 100 determines if the response is correct. To do so, the system 100 accesses the video content database 330 to determine the set of correct answers associated with the selected redacted video content. The system 100 may employ an answer recognition algorithm that recognizes the response as correct even if the response is spelled incorrectly or only partially matches one of the stored correct answers. In some embodiments, the system recognizes a response as correct if it matches a predetermined percentage of one or more of the stored correct answers.

If the user's response is correct, at block 540 the system 100 awards incentives to the user before proceeding to block 545. The system 100 may update an incentives display 275 and/or update the user database 335 to reflect newly awarded incentives. In some embodiments, the system 100 may simply award a fixed number and type of incentives to the user for a correct response. Alternatively, the system 100 may access incentives rules associated with the redacted video content in the video content database 330. The system 100 may then award incentives in accordance with the associated rules. For example, the system may access associated incentives rules that dictate the quantity and/or type of incentives that should be awarded. The quantity and/or type of incentives awarded to the user for a correct response may be determined in part by the time elapsed or remaining when the user submits a response.

If the response is incorrect at decision block 535, processing continues at block 545. In some embodiments, the system 100 may award incentives to the user even if the response is incorrect. In such embodiments, the system 100 will award incentives as described previously at block 540.

At block 545, the system 100 reveals the identity of the redacted video content using sounds, video, text or images displayed on the user's browser. To do so, the system 100 accesses identifying information stored in association with the redacted video content in the video content database 330. As previously described, the system 100 may reveal different kinds of identity information and may not necessarily reveal the graphics or sound associated with the specific redacted element. In some embodiments, however, the system 100 may display unredacted video content or an excerpt thereof to reveal the identity of the redacted element.

Typically, at block 545, the system 100 will simultaneously reveal to the user whether their response was correct or incorrect using sounds, video, text or images displayed on the user's browser. However, the system 100 may reveal this information to the user later or in another manner. In some embodiments, the system 100 may also notify others regarding the user's performance by one or more of the following: sending a notice to the user's challenger; sending a message or notification for broadcast via a social networking site like Facebook, MySpace, and/or Twitter; or updating a “leaderboard” on an associated site.

At block 550, the system 100 serves information to the user regarding replay, login and challenge options. For example, the system 100 may provide means for the user to play another round of the game. If the user requests a replay via these means, the system 100 may repeat blocks 510-555 one or more times.

The system 100 may also provide means for the user to log into the system. If the user provides sufficient login information (e.g., a correct username and password), the system 100 updates the user database 335 to reflect newly awarded incentives and/or update the user database 335 to reflect the user's recent quiz history (e.g., the identity of the redacted video content that was viewed). If the user does not have an existing account in the user database 335, the system 100 may require the user to provide sufficient information to establish a new account.

The user may also log into an associated site, and not the system 100 itself, to facilitate tracking of the user. For example, the user may provide login information for an associated social networking site, such as Facebook or MySpace.

After the user logs into the system 100 or an associated site, the system 100 may monitor the user's activity by cookies, web beacons, or similar tracking means.

At block 550, the system 100 may also display information regarding challenge modes or options to the user, including a live challenge mode. The system 100 may request the user to provide identifying information regarding the other users they would like to challenge (“challengers”) such as an email address or username. The system 100 notifies the challengers of the challenge using this identifying information.

The system 100 permits head-to-head competition if the user selects a live challenge mode. In a live challenge mode, the system 100 allows one user to play against one or more other users. In the live challenge mode, the system may deliver the same redacted video content to all users. A user that is the first to correctly respond to the query in the interactive advertising quiz receives the incentives for that quiz. If one of the users successfully answers the posed question in an interactive advertising quiz, the system may halt the presentation of the quiz to the other users. Alternatively, the system may present different redacted video content to all users. Each user responds to the query associated with the redacted video content that they are presented, and the system maintains a running score of all users as the users compete against each other. During the challenge mode, the system 100 may display additional information to the users about the competitors, such as correct answers provided by competitors or scoring updates of all competitors.

The system 100 may permit other types of challenge modes. For example, a first user may challenge a second user to take the same quiz previously completed by the first user. In such embodiments, if the second user accepts the challenge, the system 100 presents to the second user the redacted video content that was shown to the first user. The system 100 may then notify the first user regarding the second user's performance and/or notify the second user regarding the first user's performance.

In a live challenge or other challenge mode, the system 100 may determine a winner and notify the challengers of the winner's identity. The time elapsed or remaining may be a factor the system 100 uses to determine a winner as between two or more challengers. That is, the system may award greater incentives to those users that correctly respond to an interactive advertising quiz in a shorter timeframe.

It will be appreciated that the live challenge or challenge modes of the interactive advertising quiz may occur in the context of (and between members of) a social networking site, like Facebook, MySpace, or similar.

Returning to FIG. 5, at block 555, the system 100 updates the user database 335 and presentation record database 340 to reflect the user's participation in the quiz and/or any awarded incentives. Recording such information allows the user to be more accurately targeted in the future, as well as allows associated advertisers to be billed for the delivered advertising video content.

FIG. 6 is a flowchart of a process 600 implemented by the selection module 315 for selecting redacted video content for an interactive advertising quiz. As shown in FIG. 6, the process 600 begins at block 605 when the system 100 receives information regarding the user, the referring media site and/or the requested media shown to the user. The system 100 may also receive certain data previously received in the quiz request from the media site. Although not shown, the system 100 may also retrieve personal information about the user from the user database 335. For example, the system 100 may retrieve the user's zip code, age, gender, or other demographic information.

At block 610, the system 100 identifies a candidate redacted video content based on desired criteria that may include the metadata received, the referring media site, the requested media and/or the user's personal information. The system 100 queries the video content database 330 to retrieve redacted video content that matches the desired criteria. That is, the system identifies stored video content having metadata that indicates that the video content meets the desired criteria. For example, the video content may by characterized by metadata indicating that the video content would be interesting to the user based on the user's personal information (e.g., age, gender, profession, income level, education level, and interests). As other examples, video content may be selected because it is similar to the referring media site (e.g., the video content shares a common subject matter or similar target demographic audiences with the referring media site), or because the video content is similar to the requested media (e.g., the video content has similar subject matter, similar genre, or similar target demographic audience to the requested media). The query may not require an exact match between the desired criteria and the characterized stored video content, only substantial similarity. Additionally, the query may return not a single redacted video content, but rather a rank-ordered list of potential candidates based on a search algorithm. The system 100 would then choose one of the top-ranked potential candidates.

At block 615, the system 100 accesses the user's quiz history from the user database 335. At decision block 620, the system 100 determines if the user has previously viewed the candidate redacted video content. If the user previously viewed the candidate and correctly responded to its associated question, then the system 100 returns to block 610 to select another candidate (e.g., the next candidate from a rank-ordered list). Otherwise, at block 625, the system 100 selects the candidate redacted video content for use in the interactive advertising quiz.

One skilled in the art will appreciate that the system and method described may improve consumer recollection of presented advertisements by causing the consumer to actively think about the information being presented, rather than passively watching the information or avoiding the information completely. The system and method may also improve the rate of consumer participation in interactive advertising quizzes by tailoring each quiz to the user's demographic, geographic, and lifestyle groups and/or their tastes in media.

Although this application describes a system and method used in conjunction with media sites, one skilled in the art will appreciate that the described systems and methods could also be utilized in conjunction with other types of websites, such as social networking sites like Facebook, MySpace or similar, or be implemented as a stand-alone software application.

Those skilled in the art will appreciate that the blocks shown in FIGS. 4-6 may be altered in a variety of ways. For example, the order of the blocks may be rearranged, blocks may be performed in parallel, shown blocks may be omitted, other blocks may be included or some blocks may be repeatedly or iteratively performed, etc.

For clarity, the processes shown in FIGS. 4-6 were described previously as being performed by particular elements of the system 100 of FIG. 3. However, these processes may also be performed by other elements, or in other systems, or manually by a user, whether or not such elements or systems or manual steps are described herein.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A method in a computing system for presenting an interactive advertising quiz to users, the method comprising:
receiving a request for an interactive advertising quiz that is to be presented following the delivery of media to a user;
selecting video content for inclusion in an interactive advertising quiz, the video content having a redacted element and selected based on one or more characteristics of the user;
selecting a question for inclusion in the interactive advertising quiz, the question relating to the redacted element in the video content;
presenting the selected video content and question to the user following the delivery of media to the user;
receiving a response from the user regarding the question related to the redacted element; and
awarding an incentive to the user for a correct response;
wherein code implementing the method is stored in a memory of the computing system for execution by a processor of the computing system.

2. The method of claim 1, wherein the characteristics of the user are the user's personal information.

3. The method of claim 1, wherein the personal information is selected from the group consisting of age, gender, profession, income level, education level, and interests.

4. The method of claim 1, wherein the video content is further selected based one or more characteristics of the media that is delivered to user.

5. The method of claim 4, wherein the characteristics of the media are selected from a group consisting of the genre, subject matter, or target audience of the media.

6. The method of claim 1, wherein the video content is further selected based on an identity of past interactive advertising quizzes that were responded to by the user.

7. The method of claim 1, further comprising revealing an identity of the redacted element.

8. The method of claim 7, wherein revealing the identity of the redacted element comprises displaying to the user a brand of a product or service that has been redacted.

9. The method of claim 7, wherein revealing the identity of the redacted element comprises displaying to the user unredacted video content which contains the redacted element.

10. The method of claim 1, further comprising presenting an option to the user to challenge another user in an interactive advertising quiz.

11. The method of claim 10, further comprising receiving an indication from the user as to an identity of the other user that is to be challenged.

12. The method of claim 11, further comprising presenting the selected video content and question to the other user.

13. A system for presenting an interactive advertising quiz to users, the system comprising:
a redaction module configured to redact elements from video content in order to create redacted video content;
a categorization module configured to characterize the redacted video content and store the characterization of the redacted video content in association with the redacted video content;
a selection module configured to, upon receipt of a request for an interactive advertising quiz, select redacted video content for inclusion in the interactive advertising quiz based at least in part on the stored characterization of the redacted video content;
a presentation module configured to present the selected redacted video content to a user during the interactive advertising quiz, to receive a response from the user to a question posed in association with interactive advertising quiz, and to analyze the received response to determine if the response is correct; and
a billing module configured to permit the system to bill an advertiser for the presentation of the redacted video content during the interactive advertising quiz.

14. The system of claim 13, wherein the redaction module redacts elements from at least a portion of the video content by removing elements.

15. The system of claim 13, wherein the redaction module redacts elements from at least a portion of the video content by obscuring elements.

16. The system of claim 13, wherein the redaction module redacts elements selected from the group consisting of: a brand, an object, a person, or a sound.

17. The system of claim 13, wherein the presentation module is further configured to reveal an identity of the redacted element.

18. The system of claim 17, wherein the presentation module reveals the identity of the redacted element by displaying to the user a brand of a product or service that has been redacted.

19. The system of claim 17, wherein the presentation module reveals the identity of the redacted element by displaying to the user unredacted video content which contains the redacted element.

20. The system of claim 13, wherein the presentation module is further configured to present an option to the user to challenge another user in an interactive advertising quiz.

21. The system of claim 20, wherein the presentation module is further configured to receive an indication from the user as to an identity of the other user that is to be challenged.

22. The system of claim 21, wherein the presentation module is further configured to present the selected video content and question to the other user.

23. The system of claim 13, wherein the presentation module is further configured to award incentives to the user if the response is correct.

24. A method in a computing system for processing video content for use in an interactive advertising quiz, the method comprising:
receiving video content from an advertiser;
redacting an element from at least a portion of the received video content to create redacted video content, wherein the element is selected from the group consisting of a brand, an object, a person, or a sound;
receiving a question associated with the element that is redacted in the redacted video content;
storing the redacted video content in conjunction with the question associated with the redacted element; and
providing the stored redacted video content and the stored question in response to a request for an interactive advertising quiz;
wherein code implementing the method is stored in a memory of the computing system for execution by a processor of the computing system.

25. The method of claim 24, wherein redacting the element from at least a portion of the received video content consists of removing the element.

26. The method of claim 24, wherein redacting the element from at least a portion of the received video content consists of obscuring the element.

27. The method of claim 24, further comprising:
receiving a characterization of the redacted video content; and
storing the redacted video content in association with the characterization of the redacted video content.

28. The method of claim 27, wherein the request for an interactive advertising quiz includes a characterization of the requested video content in the interactive advertising quiz, and wherein the stored redacted video content is provided if the received characterization is similar to the stored characterization.

29. The method of claim 24, wherein the request for the interactive advertising quiz is received from a media site.

30. The method of claim 29, wherein the request is received following the presentation of a piece of media.
